(19) United States
(12) Patent Application Publication
(10) Pub. No.: US 2008/0277052 A1
(43) Pub. Date: Nov. 13, 2008

(54) Method and Apparatus for Making Continuous Form Structures with Used Tires

(75) Inventors: Stephen J. Pierz, Peoria, IL (US); John M. Spangler, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/851,666

(22) Filed: Sep. 7, 2007

Related U.S. Application Data
(63) Continuation-in-part of application No. 11/801,401, filed on May 9, 2007.

(51) Int. Cl. B29C 47/00

(52) U.S. Cl. 156/244.11; 156/500

(57) ABSTRACT

A method and apparatus for making a structure having a continuous form at a site. The method and apparatus includes providing a combination of a supply of tire segments and a solid polyurea component, mixing a liquid polyurea component with the combination, and extruding the mixture through an outlet to create a continuous affixed form at the site.

This application is a continuation-in-part of U.S. patent application Ser. No. 11/801,401, entitled “Method and Apparatus for Making Continuous Form Structures with Used Tires”, filed May 9, 2007.

### TECHNICAL FIELD

This disclosure relates generally to a method and apparatus for making continuous form structures and, more particularly, to a method and apparatus for making form structures using recycled tires.

### BACKGROUND

Typical continuous-form structures, such as curbs along streets and sidewalks, may be created by extruding concrete into the desired shape, using a mobile machine designed and built for the purpose. The applied concrete has a consistency that allows it to be extruded while maintaining the desired form. No pre-built forms are needed. Thus, creation of the structure is greatly simplified and accelerated.

Over time, however, the concrete form, e.g., the curb, becomes prone to damage. Freezing and thawing, salt erosion, moisture absorption, and contact by vehicles such as snow removal trucks all contribute to spalling and cracking of the structure.

Used tires create an enormous disposal problem, and are found by the millions. The issue of used tire disposal has led to numerous techniques for recycling the tires and the tire materials. For example, tires may be shredded into fine particles for various uses.

Depicting one particular example of using tire materials, in U.S. Pat. No. 6,964,125, Harris discloses a process in which recycled tire rubber is molded into forms that create flexible curb sections. The sections may then be connected by way of couplers to make a curb for various applications.

The process disclosed by Harris, however, does not allow for a continuous curb to be constructed, but rather is limited to building the curb in discrete sections. Furthermore, Harris cannot form a curb that is affixed at the site, but must rely on fasteners such as spikes to secure the curb to the ground.

The present disclosure is directed to overcoming one or more of the problems as set forth above.

### SUMMARY

In one aspect of the present disclosure a method for making a structure having a continuous form at a site is disclosed. The method includes providing a combination of a supply of tire segments and a solid polyurea component, mixing a liquid polyurea component with the combination, and extruding the mixture through an outlet to create a continuous affixed form at the site.

In another aspect of the present disclosure an apparatus for making a structure having a continuous form at a site is disclosed. The apparatus includes at least one hopper for at least one of a supply of tire segments and a solid polyurea component, a tank for a liquid polyurea component, a mixer located at outlets of the at least one hopper and the tank, an extruder located proximate the mixer, the extruder having a formed outlet, and a mobile platform supporting the at least one hopper, tank, mixer and extruder.

In another aspect of the present disclosure a method for making a structure having a continuous form at a site is disclosed. The method includes the steps of providing a supply of tire segments, combining a solid polyurea component, mixing a liquid polyurea component with the combination of tire segments and solid polyurea component, and extruding the mixture through an outlet to create a continuous affixed form at the site.

### BRIEF DESCRIPTION OF THE DRAWINGS

FIG. 1 is a diagrammatic illustration of an apparatus suited for use with the present disclosure;

FIG. 2 is a diagrammatic illustration of a form structure at a site;

FIG. 3 is a block diagram of an aspect of the apparatus of FIG. 1;

FIG. 4 is a flow diagram of a method suited for use with the present disclosure;

FIG. 5 is a diagrammatic illustration of an alternate embodiment of the apparatus of FIG. 1;

FIG. 6 is a block diagram of an aspect of FIG. 5;

FIG. 7 is a block diagram of another aspect of FIG. 5;

FIG. 8 is a flow diagram of an alternate method suited for use with the present disclosure; and

FIG. 9 is flow diagram of another alternate method.

### DETAILED DESCRIPTION

Referring to the drawings, a method and apparatus 100 for making a structure 202 having a continuous form 204 at a site 200 is shown. The structure 202 is depicted for exemplary purposes as a curb, for example for use on a road. However, other types of structures 202 may be constructed as well, such as dividers, barricades, and the like.

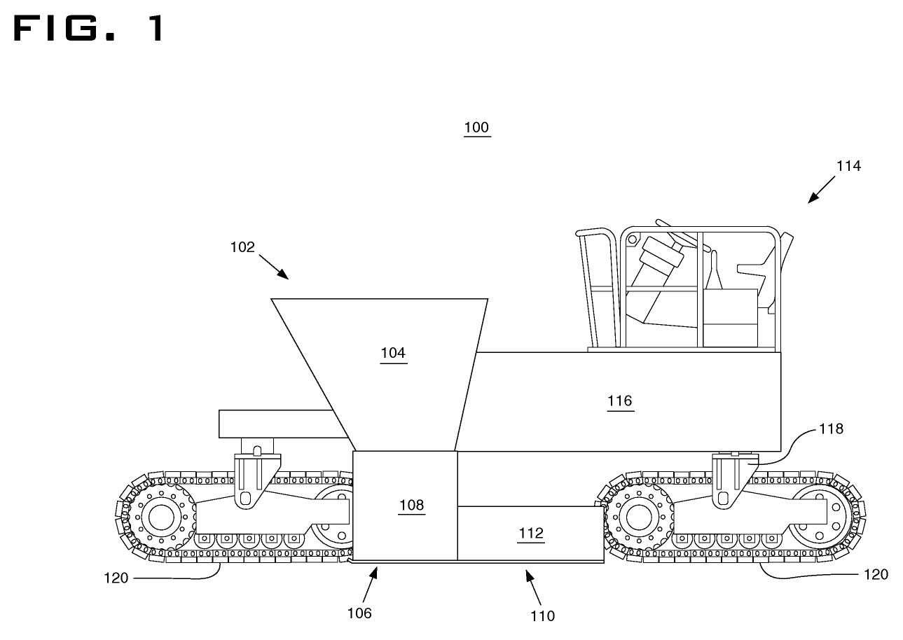

With particular reference to FIG. 1, apparatus 100 may include means 102 for providing a supply of tire segments, such as a tire segment container 104. The tire segment container 104 may be configured as a hopper. A means 106 for heating the tire segments, i.e., a heater 108, provides thermal energy sufficient to heat the tire segments to a flow consistency. A means 110 for extruding, i.e., an extruder 112, may then extrude the heated tire segments into a desired, continuous-form shape.

The components described above may be mounted as an assembly on a mobile platform 114, such as a mobile machine. The mobile platform 114 may include a prime mover 116 to provide motive power. Prime mover 116 may be an internal combustion engine, an electric motor, or any of a variety of types of power sources suitable for propelling the mobile platform 114. Drivably engaged to the prime mover 116 is a drive train 118, which may include such components (not shown) as a transmission, transfer case, drive shaft, clutch, axles, and such. A plurality of ground engaging members 120, such as tires or tracks, are drivably engaged to the drive train 118, and are in contact with the ground to transform power from the prime mover 116 to motion of the mobile platform 114. The mobile platform motion may be controlled to be in cooperation with the rate at which the heated tire segments are extruded.

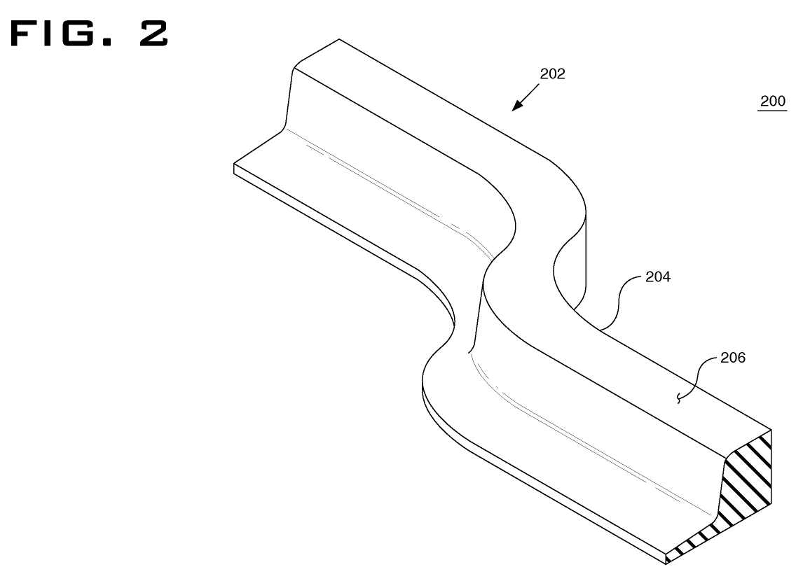

FIG. 2 illustrates an example of a structure 202 having a continuous form 204 at a site 200. The structure 202 is depicted as a curb. The structure 202 may have a coating 206 applied to provide protection or coloring. As an alternative to coloring the structure 20 by application of a coating 206, a desired color dye may be added to the tire segments at some step prior to extrusion.

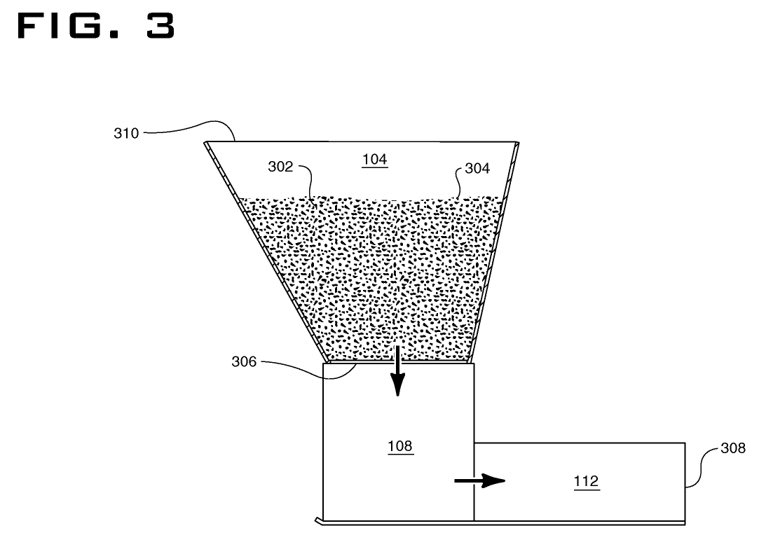

In FIG. 3, portions of the apparatus 100 of FIG. 1 are shown diagrammatically for further description. The tire segment container 104 is shown with a load of tire segments 302, which have been shredded or cut to a desired particle size. It may be necessary to continuously load the container 104 during operation, by adding tire segments at a container inlet opening 310. This may be accomplished by having trucks or other vehicles move along with the apparatus and load tire segments as needed.

Reinforcing material 304 may be added to the tire segments 302. For example, cut fiberglass strands may be added to strengthen the form 204. As another example, cut or shredded steel belt material may be left with the tire segments to provide strength to the finished product. The reinforcing material used would not be affected by the heat applied to the tire segments, yet would help to bond the tire material together for a more durable structure. The coating 206 may be applied to prevent pieces of reinforcing material 304 from extending beyond the outer surface of the structure 202, in particular when steel belt portions are used. As an alternative, the finished form 204 may be ground to smooth any reinforcing material 304 that protrudes.

A container outlet opening 306 provides a path to the heater 108 for the tire segments 302. The flow of material may be prompted by gravity, or may be enabled by some other means, such as an auger (not shown). The heater 108 may be controlled such that the tire segments are heated to a flow consistency, i.e., the tire segments may flow as one mass but still have enough solid character to maintain an extruded shape during cooling. Control of the heater 108 may be a factor of such parameters as the tire segment material composition, the size of the segments, the size of the form being produced, and the like. Typically, the tire segments will be of a wide variety of material mixes, and thus control of the heater 108 may require regular monitoring and modulation.

The heated tire segments are delivered to the extruder 112, which forces the tire material through a formed outlet 308. The formed outlet 308 is shaped to extrude the heated tire segments to create a desired continuous affixed form 204 at the site 200. The formed outlet 308 may be removable and replaceable to allow for the choice of formed outlets of various shapes and sizes.

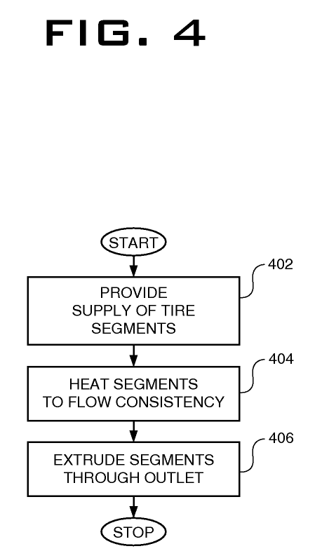

Referring to FIG. 4, a flow diagram illustrating a method for making a structure 202 having a continuous form 204 at a site 200 is shown. In a first control block 402, a supply of tire segments from used tires is provided. Optionally, a reinforcing material 304 may be provided as well. In a second control block 404, the tire segments are heated to a flow consistency, i.e., the tire segments are heated to a point in which they begin to flow. In a third control block 406, the heated tire segments are extruded through a formed outlet 308 to create an affixed form 204 at the site 200. The formed outlet 308 shapes the heated tire segments into the desired form 204 during extrusion, and the form 204 maintains a constant shape.

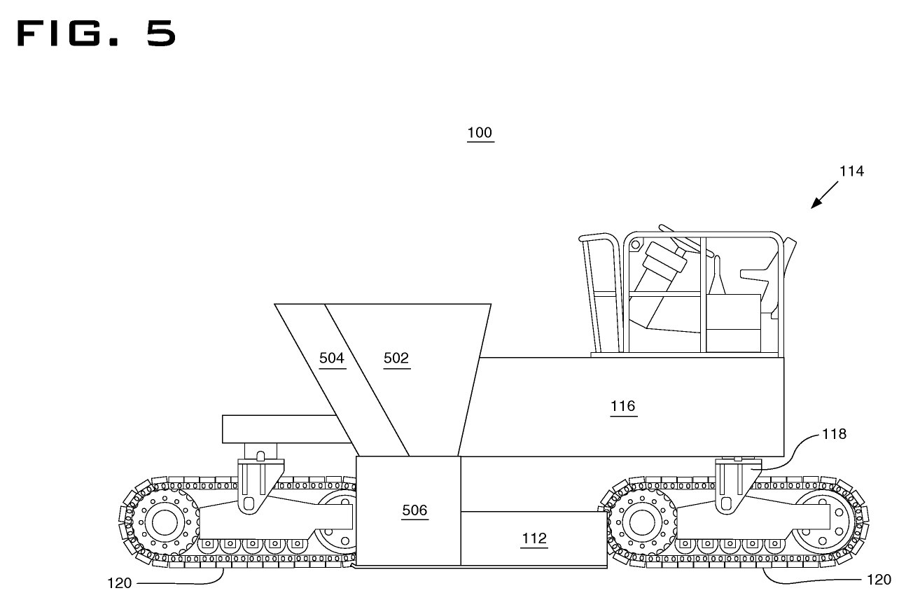

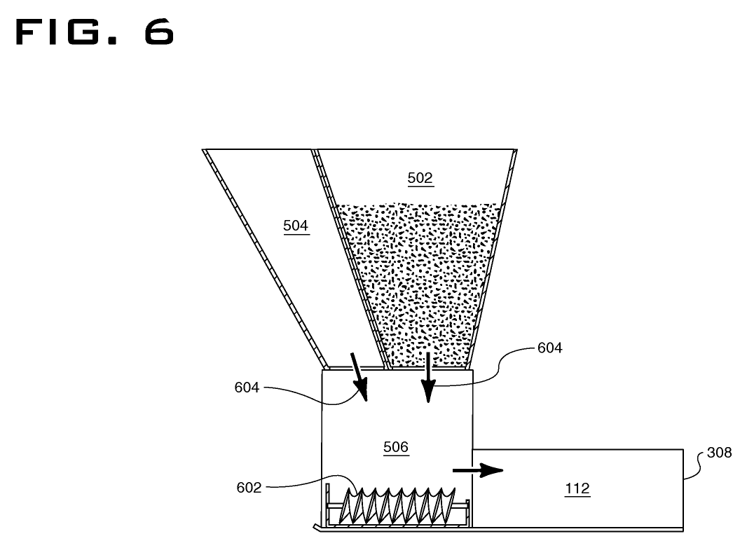

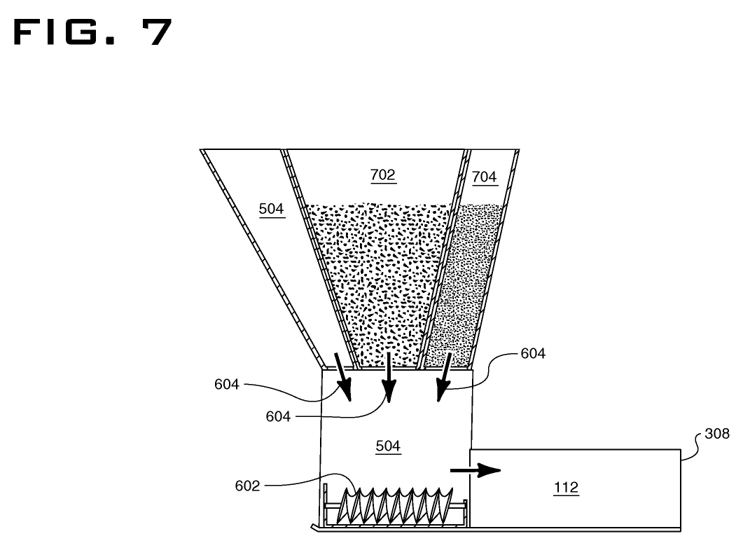

FIG. 5 illustrates an alternate embodiment of the present disclosure. In FIG. 5, a hopper 502 is used to contain a combination of a supply of tire segments and a solid polyurea component. In addition, a tank 504 is used to contain a liquid polyurea component. A mixer 506 is located at outlets 604 of the hopper 502 and tank 504, as shown in more detail in FIGS. 6 and 7.

The embodiment of FIG. 5 uses a two part polyurea to enable forming and molding of the tire segments rather than application of heat. As is well known, two part polyurea compounds harden quickly, e.g., within a matter of minutes, provide a very durable hardened product, and contain virtually no volatile organic compounds (VOCs), thus making them an environmentally friendly alternative to other techniques for molding tire segments. The cost of the polyurea may offer savings over the continued application of heat, as the energy consumption of the unheated process may be less. It is possible, however, that a type of polyurea that either requires or benefits from an application of heat may be used. In this case, a heater such as the one depicted in FIGS. 1 and 3 may be added.

It is noted that the hopper 502, tank 504 and mixer 506 of FIG. 5, and similar components in FIGS. 6 and 7, are shown in block diagram form for descriptive purposes only, and are not meant to represent actual physical structure or layout. Any suitable combination of sizes, shapes and locations of these components may be used.

FIG. 6 depicts an arrangement in which one hopper 502 containing a combination of tire segments and solid polyurea component is contained. For example, the tire segments and solid polyurea component may be combined elsewhere in desired proportions and added to the hopper 502. Outlets 604 of the hopper 502 and the tank 504 deliver the combination of tire segments and solid polyurea component and the liquid polyurea component to the mixer 506. The mixer 506 includes a mixing device 602, such as a screw type mixing device. Alternatives may include paddle mixers, tumblers, or any other suitable technique for mixing. The mixing device 602 may be disposable, i.e., may be easily removed and replaced when needed due to the setup time of the polyurea.

The mixture of tire segments and polyurea may then be moved through the extruder 112 and out the formed outlet 308 to create a continuous affixed form at the site. The form may then be coated for color or texture if desired, as described above.

FIG. 7 differs from FIG. 6 in that a first hopper 702 contains a supply of tire segments and a second hopper 704 contains a solid polyurea component. The contents of the first and second hoppers 702,704 may then be combined in any desired proportion prior to being mixed with the liquid polyurea component from the tank 504. This offers an advantage in that an operator at the site may adjust the proportions for the job. For example, it may be desired to increase or decrease the ratio of tire segments to solid polyurea to alter properties of the extruded material.

Once combined, the tire segments and solid polyurea component may then be mixed with the liquid polyurea component, and the mixture may be extruded as described above. The ratio of the combination with the liquid polyurea component may also be set by the operator for additional control of properties of the final mixture.

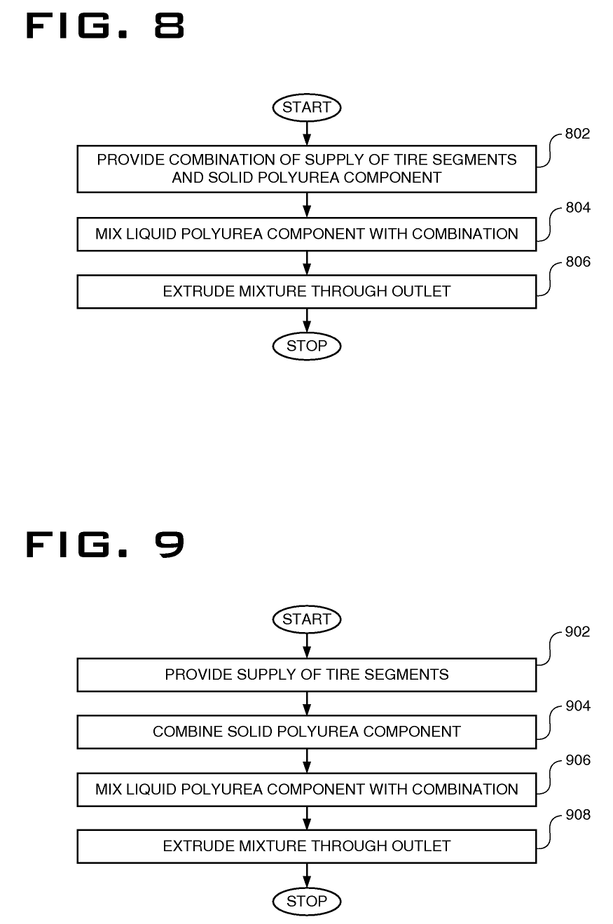

FIG. 8 illustrates a flow diagram representative of a method for the setup of FIG. 6. In a first control block 802, a combination of a supply of tire segments and a solid polyurea component is provided. The tire segments may be obtained from shredded or cut used tires. In a second control block 804, a liquid polyurea component is mixed with the combination. Prior to hardening of the polyurea, the mixture is extruded through a formed outlet 308, as shown in a third control block 806.

In FIG. 9, a variation of the process of FIG. 8 is shown. In a first control block 902, a supply of tire segments is provided. In a second control block 904, a solid polyurea component is combined with the tire segments. In a third control block 906, a liquid polyurea component is mixed with the combination. In a fourth control block 908, the mixture is extruded through the formed outlet 308.

### INDUSTRIAL APPLICABILITY

As an example of application of the present disclosure, an apparatus 100 such as that depicted in FIG. 1 may be used to extrude a continuous form 204 of a fixed shape directly at a site 200. The form 202 may be a curb for a street, sidewalk or garden and may be formed from tire segments. The use of segments from used tires provides a use for the tires and creates a curb that is less prone to cracking than traditional concrete curbs. In addition, the curbs would be more resistant to damage from freezing and thawing, salt, and impact. The curbs would also be fully recyclable, i.e., they can be removed, shredded, and re-used.

Other aspects can be obtained from a study of the drawings, the specification, and the appended claims.

What is claimed is:

1. A method for making a structure having a continuous form at a site, comprising the steps of:
providing a combination of a supply of tire segments and a solid polyurea component;
mixing a liquid polyurea component with the combination; and
extruding the mixture through an outlet to create a continuous affixed form at the site.

2. A method, as set forth in claim 1, wherein providing a supply of tire segments includes the step of providing a supply of segments from used tires.

3. A method, as set forth in claim 1, wherein providing a combination of a supply of tire segments and a solid polyurea component includes the step of providing a combination of a desired proportion of tire segments with the solid polyurea component.

4. A method, as set forth in claim 1, wherein providing a combination of a supply of tire segments and a solid polyurea component includes the step of combining a supply of tire segments with a desired proportion of a solid polyurea component.

5. A method, as set forth in claim 1, wherein extruding the mixture through an outlet includes the step of extruding the mixture through an outlet that shapes the flow of segments into the form.

6. A method, as set forth in claim 1, wherein extruding the mixture through an outlet to create an affixed form includes the step of creating a form having a constant shape.

7. A method, as set forth in claim 1, further including the step of applying a coating to the form.

8. A method, as set forth in claim 7, wherein applying a coating includes the step of applying a coating of a desired color to the form.

9. A method, as set forth in claim 2, wherein providing a supply of tire segments includes the step of providing a desired color dye to the tire segments.

10. A method, as set forth in claim 1, wherein mixing a liquid polyurea component with the combination includes the step of mixing a desired amount of liquid polyurea component to the combination.

11. An apparatus for making a structure having a continuous form at a site, comprising:
at least one hopper for at least one of a supply of tire segments and a solid polyurea component;
a tank for a liquid polyurea component;
a mixer located at outlets of the at least one hopper and the tank;
an extruder located proximate the mixer, the extruder having a formed outlet; and
a mobile platform supporting the at least one hopper, tank, mixer and extruder.

12. An apparatus, as set forth in claim 11, wherein the at least one hopper includes a hopper for a combination of a supply of tire segments and a solid polyurea component.

13. An apparatus, as set forth in claim 11, wherein the at least one hopper includes a first hopper for a supply of tire segments and a second hopper for a solid polyurea component.

14. An apparatus, as set forth in claim 11, wherein the mixer includes a mixing device.

15. An apparatus, as set forth in claim 14, wherein the mixing device is disposable and replaceable.

16. An apparatus, as set forth in claim 11, wherein the formed outlet of the extruder is shaped to extrude a mixture of the supply of tire segments, the solid polyurea component and the liquid polyurea component to create a desired continuous affixed form at the site.

17. An apparatus, as set forth in claim 11, wherein the mobile platform includes:
a prime mover;
a drive train drivably engaged to the prime mover; and
a plurality of ground engaging members drivably engaged to the drive train.

18. A method for making a structure having a continuous form at a site, comprising the steps of:
providing a supply of tire segments;
combining a solid polyurea component;
mixing a liquid polyurea component with the combination of tire segments and solid polyurea component; and
extruding the mixture through an outlet to create a continuous affixed form at the site.
